(19) United States
(12) Patent Application Publication
(10) Pub. No.: US 2026/0164451 A1
(43) Pub. Date: Jun. 11, 2026

(54) NEW RADIO RESOURCE POOL CONFIGURATION FOR COEXISTENCE WITH LONG TERM EVOLUTION SIDELINK

(71) Applicant: Telefonaktiebolaget LM Ericsson (publ), Stockholm (SE)

(72) Inventors: Ratheesh Kumar MUNGARA, Sundbyberg (SE); Ricardo BLASCO SERRANO, Espoo (FI); Majid GERAMI, Lund (SE)

(73) Assignee: Telefonaktiebolaget LM Ericsson (publ), Stockholm (SE)

(21) Appl. No.: 19/129,022

(22) PCT Filed: Nov. 15, 2023
(86) PCT No.: PCT/EP2023/081896

§ 371 Date: May 12, 2025

Related U.S. Application Data
(60) Provisional application No. 63/425,458, filed on Nov. 15, 2022.

(51) Int. Cl. H04W 72/25; H04W 72/0446

(52) U.S. Cl. CPC H04W 72/25; H04W 72/0446

(57) ABSTRACT

A method, system and apparatus for New Radio (NR) resource pool configuration for coexistence with Long Term Evolution (LTE) sidelink are disclosed. According to one aspect, a method in a wireless device (WD) includes determining whether to perform a sidelink (SL) transmission based at least in part on whether a corresponding physical sidelink feedback channel (PSFCH) transmission will take place in a time slot that is aligned between New Radio (NR) and Long Term Evolution (LTE) resource pools.

### TECHNICAL FIELD

The present disclosure relates to wireless communications, and in particular, to New Radio (NR) resource pool configuration for coexistence with Long Term Evolution (LTE) sidelink.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

### Sidelink

Sidelink (SL) is the name in the 3GPP specifications of the interface used for direct communication between devices, also referred to as device-to-device (D2D) communications. This is in comparison to typical cellular communications in which two devices communicate by means of uplink (UL) and downlink (DL) transmissions. The sidelink interface is sometimes referred to as the PC5 interface. The UL/DL interface is sometimes referred to as the Uu interface.

3GPP specified the sidelink (SL) as part of 3GPP Technical Release 12 (3GPP Rel-12). The target use case (UC) was Proximity Services (communication and discovery). Support was enhanced during 4GPP Rel-13. In 3GPP Rel-14, the LTE sidelink was extensively redesigned to support vehicular communications (commonly referred to as V2X or V2V). Support was again enhanced during 3GPP Rel-15. From the point of view of the lowest radio layers, the LTE SL uses broadcast communication. That is, transmission from a WD targets any receiver that is in range.

In 3GPP Rel-16, 3GPP introduced the sidelink for the 5G new radio (NR). The driving UC were vehicular communications with more stringent requirements than those typically served using the LTE SL. To meet these requirements, the NR SL is capable of broadcast, groupcast, and unicast communications. In groupcast communication, the intended receivers of a message are typically a subset of the vehicles near the transmitter, whereas in unicast communication, there is a single intended receiver.

Both the LTE SL and the NR SL may operate with and without network coverage and with varying degrees of interaction between the WDs (user equipment) and the NW (network), including support for standalone, network-less operation.

### Configuration and (Pre-) Configuration

In cellular systems, the network node typically configures some parameters used by the WDs. This configuration is typically signaled by a NW node (e.g., a gNB for NR, an eNB for LTE) to the WD (e.g., using radio resource control (RRC) signaling, broadcast signaling such as master information block (MIB) or system information block (SIB), or some other type of signaling). This is applicable to WDs performing sidelink transmissions if they are in coverage of a network node.

WDs that are out of network coverage but participate in sidelink communications, may be provided the corresponding parameters by means of a pre-configuration (e.g., stored in the subscriber identity module (SIM)).

Unless explicitly stated, the terms configuration or pre-configuration are used to denote both ways of providing the corresponding configuration/parameters to a WD.

For vehicle-to-another station (V2X) applications, (pre-) configurations may be defined by some road authorities and used by manufacturers of devices and chipset. That means that the (pre-) configuration may not be provided dynamically to the WD but statically given at the time of manufacturing, etc.

### LTE Sidelink

The LTE SL allows for transmitting directly from transmitter (TX) wireless device (WD) to receiver (RX) WD. LTE SL transmissions take place on a subframe, which consist of 14 orthogonal frequency division multiplex (OFDM) symbols. Note that the last OFDM symbol is left unused, as a guard period (GP). A subframe lasts 1 ms.

The LTE SL transmissions take place on physical (PHY) channels. Two PHY channels that are of interest are the Physical Sidelink Control Channel (PSCCH) and the Physical Sidelink Shared Channel (PSCCH). In the most common configuration, PSCCH and PSSCH are transmitted adjacent in frequency.

### Resource Pools for LTE

In LTE sidelink, the radio resources are organized in terms of resource pools. A resource pool is a collection of time-frequency resources that may be used for transmitting or receiving sidelink transmissions.

In the frequency domain, a resource pool is divided in one or several sub-channels. A sub-channel is a collection of consecutive physical resource blocks (PRBs).

In the time domain, a resource pool indicates subframes that are available for performing LTE sidelink transmissions.

The sub-channel is the minimum allocation unit for PSCCH. That means that, in the most common configuration, a PSCCH+PSSCH transmission occupies an integer number of sub-channels during one subframe (including guard period (GP)).

FIG. 1 illustrates an LTE SL resource pool with L_{subch}=4 subchannels, each of them consisting of L_{RBs} PRBs.

### Sensing Procedure for LTE Sidelink Mode 4

In LTE sidelink for V2X, there are two different modes of operation: mode 3 and mode 4. Mode 4 is the mode in which a transmitter WD autonomously selects the resources in order to perform a transmission.

To avoid multiple WDs selecting the same resources for transmission, mode 4 defines a sensing procedure by which WDs detect each other's transmissions. Mode 4 sensing, among other things, defines a procedure for detecting other transmission based on received signal strength indicator (RSSI) measurements (sometimes referred to as Sidelink RSSI or S-RSSI). More specifically, an LTE WD performs an RSSI measurement in each sub-channel in each slot. Denote the measurement corresponding to subframe p and sub-channel k as

$${RSSI}_{p}^{k} .$$

To determine whether a future resource (in subframe n and sub-channel r) is likely to be occupied, it computes the value

$${S}_{n}^{r} :$$

$${S}_{n}^{r} = {\sum }_{j = 0}^{T} {RSSI}_{n - j * {P}_{step}}^{r}$$

for some values of T and Pₛₜₑₚ. That is, the LTE WD computes the average RSSI value in sub-channel r in T subframes, spaced at equal intervals of length Pₛₜₑₚ. The LTE WD aims to select only resources with low

$${S}_{n}^{r} .$$

The rationale is that it a different WD is transmitting periodically (with period Pₛₜₑₚ or a multiple thereof) the value will be high.

Note that the values in the summation are computed for a given sub-channel r.

### NR Sidelink

The NR SL allows for transmitting directly from transmitting (TX) WD to receiving (RX) WD. NR SL transmissions take place in a slot, which has 14 OFDM symbols. As for LTE, the last OFDM symbol is left unused as a guard period (GP). The duration of a slot is configurable and depends on the sub-carrier spacing. In one case, a sub-carrier spacing for NR is 15 kHz, resulting in a slot duration of 1 ms (i.e., the same as an LTE subframe).

As for LTE, the NR sidelink defines PSCCH and PSSCH. In addition (and differently from LTE), the NR sidelink also defines a Physical Sidelink Feedback Channel (PSFCH) to facilitate the feedback about whether PSSCH is successfully received or not.

### Resource Pools for NR

As for LTE, in NR sidelink, the radio resources are organized in terms of resource pools. A resource pool is a collection of time-frequency resources that may be used for transmitting or receiving sidelink transmissions.

In the frequency domain, a resource pool is divided into one or several sub-channels. A sub-channel is a collection of consecutive physical resource blocks (PRBs).

In the time domain, a resource pool indicates which slots are available for performing NR sidelink transmissions.

The sub-channel is the minimum allocation unit for PSCCH. That means that in the most common configuration, a PSCCH+PSSCH transmission occupies an integer number of sub-channels in a slot. The actual duration of the PSCCH+PSSCH transmission depends on the slot in which it is transmitted. The resource pool configuration defines two types of slots:
Slots without PSFCH resources. In these slots, a PSCCH+PSSCH transmission (including GP) spans all 14 OFDM symbols. An example is illustrated in FIG. 2; and
Slots with PSFCH resources. In these slots, a PSCCH+PSSCH transmission (including GP) spans less than OFDM symbols. The remaining symbols, at the end of the slot, are used for transmitting PSFCH and include a corresponding GP. An example is illustrated FIG. 3.

Note that in slots with PSFCH resources, the PSCCH+PSSCH transmission may come from one WD and the PSFCH transmission may come from a different WD.

The presence of PSFCHs is quite configurable (see Table 1):
In the time domain, PSFCH resources may be configured to appear every slot, every second slot, or every fourth slot; and
In the frequency domain, the configuration determines for each PRB whether it may be used for PSFCH transmission.

Among the multiple configured PSFCH resources, the RX WD selects one resource for transmitting the PSFCH based on the resource carrying the PSCCH or PSSCH and some physical layer identities, see Table 2.

TABLE 1
$Association of a PSSCH slot and sub - channel with {M}_{subch , slot}^{PSFCH} PSFCH$
resources. 3GPP Technical Standard (TS) 38.213 v 16.6.0.

$A WD is provided by sl - PSFCH - RB - Set a set of {M}_{PRB , set}^{PSFCH} PRBs in a resource$
pool for PSFCH transmission in a PRB of the resource pool. For a number of N_{subch} sub-
channels for the resource pool, provided by sl-NumSubchannel, and a number of
$PSSCH slots associated with a PSFCH slot that is less than or equal to {N}_{PSSCH}^{PSFCH} , the WD$
$allocates the [ ( i + j \cdot {N}_{PSSCH}^{PSFCH} ) \cdot {M}_{subch , slot}^{PSFCH} , ( i + 1 + j \cdot {N}_{PSSCH}^{PSFCH} ) \cdot {M}_{subch , slot}^{PSFCH} - 1 ] PRBs$
$from the {M}_{PRB , set}^{PSFCH} PRBs to slot i among the PSSCH slots associated with the PSFCH$
$slot and sub - channel j , where {M}_{subch , slot}^{PSFCH} = {M}_{PRB , set}^{PSFCH} / ( {N}_{subch} \cdot {N}_{PSSCH}^{PSFCH} ) , 0 \leq i <$
${N}_{PSSCH}^{PSFCH} , 0 \leq j < {N}_{subch} , and the allocation starts in an ascending order of i and$
$continues in an ascending order of j . The WD expects that {M}_{PRB , set}^{PSFCH} is a multiple of$
${N}_{subch} \cdot {N}_{PSSCH}^{PSFCH} .$

TABLE 2
Selection of a PSFCH resource for transmission of PSFCH. 3GPP TS
38.213 v 16.6.0.

```
A WD determines a number of PSFCH resources available for multiplexing
$HARQ - ACK information in a PSFCH transmission as {R}_{PRB , CS}^{PSFCH} = {N}_{type}^{PSFCH} \cdot {M}_{subch , slot}^{PSFCH} \cdot$
${N}_{CS}^{PSFCH} where {N}_{CS}^{PSFCH} is a number of cyclic shift pairs for the resource pool provided by$
sl-NumMuxCS-Pair and, based on an indication by sl-PSFCH-CandidateResourceType,
    - if sl-PS FCH-CandidateResourceType is configured as startSubCH,
${N}_{type}^{PSFCH} = 1 and the {M}_{subch , slot}^{PSFCH} PRBs are associated with the starting sub - channel of the$
corresponding PSSCH;
    - if sl-PSFCH-CandidateResourceType is configured as allocSubCH,
${N}_{type}^{PSFCH} = {N}_{subch}^{PSSCH} and the {N}_{subch}^{PSSCH} \cdot {M}_{subch , slot}^{PSFCH} PRBs are associated with one or more$
$sub - channels from the {N}_{subch}^{PSSCH} sub - channels of the corresponding PSSCH .$
    The PSFCH resources are first indexed according to an ascending order of the
$PRB index , from the {N}_{type}^{PSFCH} \cdot {M}_{subch , slot}^{PSFCH} PRBs , and then according to an ascending$
$order of the cyclic shift pair index from the {N}_{CS}^{PSFCH} cyclic shift pairs .$
    A WD determines an index of a PSFCH resource for a PSFCH transmission in
$response to a PSSCH reception as ( {P}_{ID} + {M}_{ID} ) mod {R}_{PRB , CS}^{PSFCH} where {P}_{ID} is a physical$
layer source ID provided by SCI format 2-A or 2-B [5, TS 38.212] scheduling the
PSSCH reception, and M_{ID} is the identity of the WD receiving the PSSCH as indicated
by higher layers if the WD detects a SCI format 2-A with Cast type indicator field value
of “01”; otherwise, M_{ID} is zero.
```

The discussion so far has considered the case of using PSFCH for transmitting hybrid automatic repeat request (HARQ)-acknowledgement (ACK) information in reception to a reception of a sidelink transmission. In later versions of the specification, it is possible to configure PSFCH resources for PSFCH transmission with conflict information (see Table 3). Note that different PSFCH resources are configured for each purpose. This disclosure is applicable to either type or to a combination of both.

TABLE 3
$Association of a PSSCH slot and sub - channel with {M}_{subch , slot}^{PSFCH} PSFCH$
resources. 3GPP TS 38.213 v 17.2.0.

$A WD is provided by sl - PSFCH - RB - Set a set of {M}_{PRB , set}^{PSFCH} PRBs in a resource$
pool for PSFCH transmission with HARQ-ACK information in a PRB of the resource
$pool . A WD can be provided by sl - PSFCH - Conflict - RB - Set a set of {M}_{PRB , set}^{PSFCH} PRBs in a$
resource pool for PSFCH transmission with conflict information in a PRB of the
resource pool. A WD expects that different PRBs are (pre)configured for conflict
information and HARQ-ACK information. For a number of N_{subch} sub-channels for the
resource pool, provided by sl-NumSubchannel, and a number of PSSCH slots associated
$with a PSFCH slot that is less than or equal to {N}_{PSSCH}^{PSFCH} , the WD allocates the$
$[ ( i + j \cdot {N}_{PSSCH}^{PSFCH} ) \cdot {M}_{subch , slot}^{PSFCH} , ( i + 1 + j \cdot {N}_{PSSCH}^{PSFCH} ) \cdot {M}_{subch , slot}^{PSFCH} - 1 ] PRBs from the$
${M}_{PRB , set}^{PSFCH} PRBs to slot i among the PSSCH slots associated with the PSFCH slot and$
$sub - channel j , where {M}_{subch , slot}^{PSFCH} = {M}_{PRB , set}^{PSFCH} / ( {N}_{subch} \cdot {N}_{PSSCH}^{PSFCH} ) , 0 \leq i < {N}_{PSSCH}^{PSFCH} , 0 \leq$
j < N_{subch}, and the allocation starts in an ascending order of i and continues in an
$acsending order of j . The WD expects that {M}_{PRB , set}^{PSFCH} is a multiple of {N}_{subch} \cdot {N}_{PSSCH}^{PSFCH} .$

### Deployment of NR and LTE Sidelinks

In practice it is likely that the NR SL will not totally replace the LTE SL but be deployed together with it. In the existing deployment model, some services will make use of the LTE SL while others will make use of the NR SL. For example, for V2X:
Service type ‘ITS safety’ (e.g., CAM) will use LTE SL; and
Service type ‘Cooperative driving’ will use NR SL.

Ideally, different time-frequency resources would be allocated to each technology, given that LTE and NR sidelinks are not compatible at PHY-layer level. However, given the scarcity of spectrum, it may be necessary to deploy them on the same time-frequency resources (i.e., co-channel). This creates coexistence issues that 3GPP is addressing in 3GPP Rel-18.

Note that LTE SL and NR SL are configured separately.

Typically, a network node provides the configuration to the different WDs. In the case of sidelink, this may be different. For example, for the case of V2X it is possible that some traffic authority in a country or region defines a set of values for LTE SL and a set of values for NR SL. All manufacturers use these values in their products for use in the country or region.

The 3GPP Rel-16 framework for coexistence between LTE and NR sidelinks de facto requires different statically assigned resources. That is, that they are provided with resource pools that contain different time-frequency resources.

For 3GPP Rel-18, 3GPP is studying new co-channel coexistence mechanisms between LTE and NR sidelinks. Preferably, they should allow for having overlapping resource pools.

LTE SL WDs perform periodic measurements in the LTE resource pool and may detect transmissions based on RSSI measurements. One precondition is that an appropriate resource pool configuration for NR SL is used. However, LTE and NR SL resource pools are configured separately. NR PSFCH transmissions may only take place in a set of periodically repeating resources according to the NR SL resource pool configuration. In some cases, two periods are defined such that the LTE periodic measurements may be useful for detecting the presence of transmissions in the resources configured for PSFCH transmissions. This sometimes does not happen.

Specifically, the logical slots corresponding to NR or LTE SL resource pools do not account for the slots carrying sidelink synchronization signals (SLSS) and reserved slots. Hence, these logical slots are not contiguous in physical time. Though PSFCH periodicity is set to a specific value, the periodic relationship between PSFCH resources in NR SL and resources used for RSSI detection in LTE SL is not always guaranteed when they operate on different scales of logical slots than in physical slots. Altogether, this yields a challenging situation at the LTE SL WDs while detecting PSFCH transmissions based on RSSI measurement. This issue may arise from misalignment between logical and physical slots.

One straightforward solution to this problem is that NR SL WD avoids transmitting PSFCH in the slots overlapping with LTE SL transmissions in time domains. But this affects the reliability and spectral efficiency of NR SL.

### SUMMARY

Some embodiments advantageously provide methods, systems, and apparatuses for New Radio (NR) resource pool configuration for coexistence with Long Term Evolution (LTE) sidelink.

Some embodiments define NR SL and LTE SL resource pool configurations, which are provided separately to the WD(s), in a dependent manner so that:
A PSCCH/PSSCH transmitting WD avoids selecting resources for PSCCH/PSSCH transmission such that there is no necessity to transmit PSFCH in the slots corresponding to misalignment between logical and physical slots with respect to PSFCH slot; and/or
A PSCCH/PSSCH receiving WD will be able to transmit PSFCH in the slots.

Thus, an LTE SL receiver using Mode 4 may compute RSSI average measurements that reflect the presence of PSFCH transmissions, if any, across the sensing window.

Some embodiments include devices that contain NR sidelink as well as devices that contain both LTE sidelink an NR sidelink, called Type-A devices in 3GPP. It may be that a single chipset implements both solutions, but it may also be that a large device includes two separate chipsets, one for each technology. A device in this case refers to an on-board communications module, for example, for a car that may perform V2X communication.

A method is provided for configuring a device using both NR SL and LTE SL in such a way that NR PSFCH transmissions are avoided on the slots that have a misalignment between logical and physical slots with respect to a PSFCH slot within the time resources overlapping with LTE SL transmission. NR SL (pre-) configuration, including sidelink resource pool, sidelink synchronization signal (SLSS), etc., may be performed to avoid or minimize the misalignment between logical and physical slots.

Some embodiments facilitate the HARQ feedback transmissions within the time resources overlapping with the LTE SL resource pool, which may have one or more of the following benefits:
Within the framework of dynamic resource pool coexistence, some embodiments maintain the NR sidelink reliability and spectral efficiency; and/or
Improved resource utilization efficiency during the coexistence of NR and LTE sidelinks.

According to one aspect, a WD configured to communicate with another WD is provided. The WD is configured to determine whether to perform a sidelink (SL) transmission based at least in part on whether a corresponding physical sidelink feedback channel (PSFCH) transmission will take place in a time slot that is aligned between New Radio (NR) and Long Term Evolution (LTE) resource pools.

According to this aspect, in some embodiments, the WD is configured to avoid selecting resources for physical sidelink control channel (PSCCH) transmission and physical sidelink shared channel (PSSCH) transmission. In some embodiments, the WD is configured to avoid selecting resources for PSCCH and PSSCH transmission only when the corresponding PSFCH transmission would take place in a time slot that is misaligned between NR and LTE resource pools. In some embodiments, the SL transmission is at least one of a PSCCH transmission and a PSSCH transmission having SL hybrid automatic repeat request (HARQ) feedback in a corresponding PSFCH transmission. In some embodiments, the WD is configured to perform the SL transmission when the corresponding PSFCH transmission would occur in a slot that is aligned between NR and LTE resource pools, and avoid performing the SL transmission when the corresponding PSFCH transmission would occur in a slot that is misaligned between NR and LTE resource pools. In some embodiments, not performing a SL transmission includes not selecting a specific resource for SL transmission. In some embodiments, a misalignment of a time slot between NR and LTE resource pools occurs when the time slots of an NR resource pool for PSFCH transmission are configured and the PSFCH transmission does not correspond to a periodically repeating pattern of resources in the LTE resource pool. In some embodiments, a misalignment of a time slot between NR and LTE resource pools occurs when the time slots of an NR resource pool for PSFCH transmission are not configured and the PSFCH transmission corresponds to a periodically repeating pattern of resources in the LTE resource pool. In some embodiments, the WD is configured as a NR type-A device and is configured to select a NR sidelink synchronization signal, SLSS, configuration that minimizes misalignment between logical and physical slots at a LTE SL WD. In some embodiments, a periodicity of NR PSFCH transmissions is 2 or 4.

According to another aspect, a method implemented in a wireless device (WD). The method includes determining whether to perform a sidelink (SL) transmission based at least in part on whether a corresponding physical sidelink feedback channel (PSFCH) transmission will take place in a time slot that is aligned between New Radio (NR) and Long Term Evolution (LTE) resource pools.

According to this aspect, in some embodiments, the method includes avoiding selecting resources for physical sidelink control channel (PSCCH) transmission and physical sidelink shared channel (PSSCH) transmission. In some embodiments, the method includes avoiding selecting resources for PSCCH and PSSCH transmission only when the corresponding PSFCH transmission would take place in a time slot that is misaligned between NR and LTE resource pools. In some embodiments, the SL transmission is at least one of a PSCCH transmission and a PSSCH transmission having SL hybrid automatic repeat request (HARQ) feedback in a corresponding PSFCH transmission. In some embodiments, the method includes performing the SL transmission when the corresponding PSFCH transmission would occur in a slot that is aligned between NR and LTE resource pools, and avoid performing the SL transmission when the corresponding PSFCH transmission would occur in a slot that is misaligned between NR and LTE resource pools. In some embodiments, not performing a SL transmission includes not selecting a specific resource for SL transmission. In some embodiments, a misalignment of a time slot between NR and LTE resource pools occurs when the time slots of an NR resource pool for PSFCH transmission are configured and the PSFCH transmission does not correspond to a periodically repeating pattern of resources in the LTE resource pool. In some embodiments, a misalignment of a time slot between NR and LTE resource pools occurs when the time slots of an NR resource pool for PSFCH transmission are not configured and the PSFCH transmission corresponds to a periodically repeating pattern of resources in the LTE resource pool. In some embodiments, the WD is configured as a NR type-A device and the method includes selecting a NR sidelink synchronization signal, SLSS, configuration that minimizes misalignment between logical and physical slots at a LTE SL WD. In some embodiments, a periodicity of NR PSFCH transmissions is 2 or 4.

According to yet another aspect, a network node configured to communicate with a wireless device, WD, is provided. The network node is configured to: configure the WD to determine whether to perform a sidelink, SL, transmission based at least in part on whether a corresponding physical sidelink feedback channel, PSFCH, transmission will take place in a time slot that is aligned between New Radio, NR, and long term evolution, LTE, resource pools.

According to this aspect, in some embodiments, the network node is configured to configure the WD to avoid selecting resources for physical sidelink control channel, PSCCH, transmission and physical sidelink shared channel, PSSCH, transmission when the corresponding PSFCH transmission would take place in a time slot that is misaligned between NR and LTE resource pools. In some embodiments, the SL transmission is at least one of a PSCCH transmission and a PSSCH transmission having SL hybrid automatic repeat request, HARQ, feedback in the corresponding PSFCH transmission. In some embodiments, the network node is configured to configure the WD to perform the SL transmission when the corresponding PSFCH transmission would occur in a slot that is aligned between NR and LTE resource pools, and avoid performing the SL transmission when the corresponding PSFCH transmission would occur in a slot that is misaligned between NR and LTE resource pools.

According to another aspect, a method implemented in a network node configured to communicate with a wireless device, WD, is provided. The method includes configuring the WD to determine whether to perform a sidelink, SL, transmission based at least in part on whether a corresponding physical sidelink feedback channel, PSFCH, transmission will take place in a time slot that is aligned between New Radio, NR, and long term evolution, LTE, resource pools.

According to this aspect, in some embodiments, the method includes configuring the WD to avoid selecting resources for physical sidelink control channel, PSCCH, transmission and physical sidelink shared channel, PSSCH, transmission when the corresponding PSFCH transmission would take place in a time slot that is misaligned between NR and LTE resource pools. In some embodiments, the SL transmission is at least one of a PSCCH transmission and a PSSCH transmission having SL hybrid automatic repeat request, HARQ, feedback in the corresponding PSFCH transmission. In some embodiments, the method includes configuring the WD to perform the SL transmission when the corresponding PSFCH transmission would occur in a slot that is aligned between NR and LTE resource pools, and avoid performing the SL transmission when the corresponding PSFCH transmission would occur in a slot that is misaligned between NR and LTE resource pools.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an LTE resource pool configuration;

FIG. 2 is an NR slot without PSFCH resources;

FIG. 3 is an NR slot with PSFCH resources;

FIG. 4 is a schematic diagram of an example network architecture illustrating a communication system connected via an intermediate network to a host computer according to the principles in the present disclosure;

FIG. 5 is a block diagram of a host computer communicating via a network node with a wireless device over an at least partially wireless connection according to some embodiments of the present disclosure;

FIG. 6 is a flowchart illustrating example methods implemented in a communication system including a host computer, a network node and a wireless device for executing a client application at a wireless device according to some embodiments of the present disclosure;

FIG. 7 is a flowchart illustrating example methods implemented in a communication system including a host computer, a network node and a wireless device for receiving user data at a wireless device according to some embodiments of the present disclosure;

FIG. 8 is a flowchart illustrating example methods implemented in a communication system including a host computer, a network node and a wireless device for receiving user data from the wireless device at a host computer according to some embodiments of the present disclosure;

FIG. 9 is a flowchart illustrating example methods implemented in a communication system including a host computer, a network node and a wireless device for receiving user data at a host computer according to some embodiments of the present disclosure;

FIG. 10 is a flowchart of an example process in a network node for New Radio (NR) resource pool configuration for coexistence with Long Term Evolution (LTE) sidelink;

FIG. 11 is a flowchart of an example process in a wireless device for New Radio (NR) resource pool configuration for coexistence with Long Term Evolution (LTE) sidelink;

FIG. 12 illustrates mismatch between logical and physical slots;

FIG. 13 illustrates mismatch between logical and physical slots;

FIG. 14 illustrates mismatch between logical and physical slots; and

FIG. 15 illustrates an NR resource pool configuration.

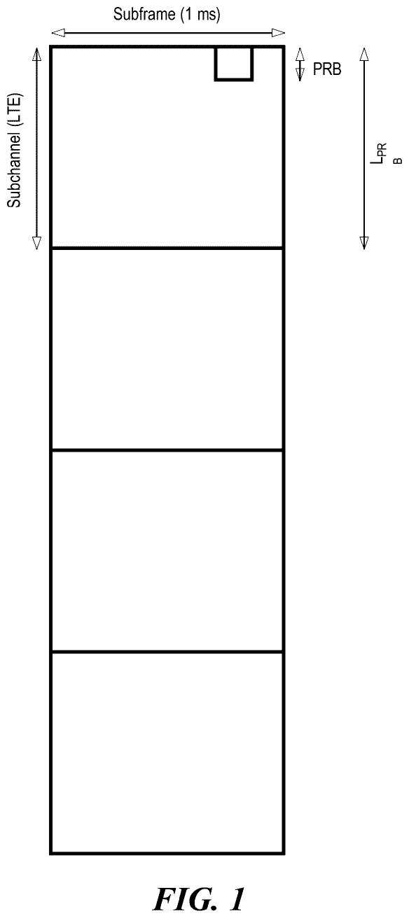

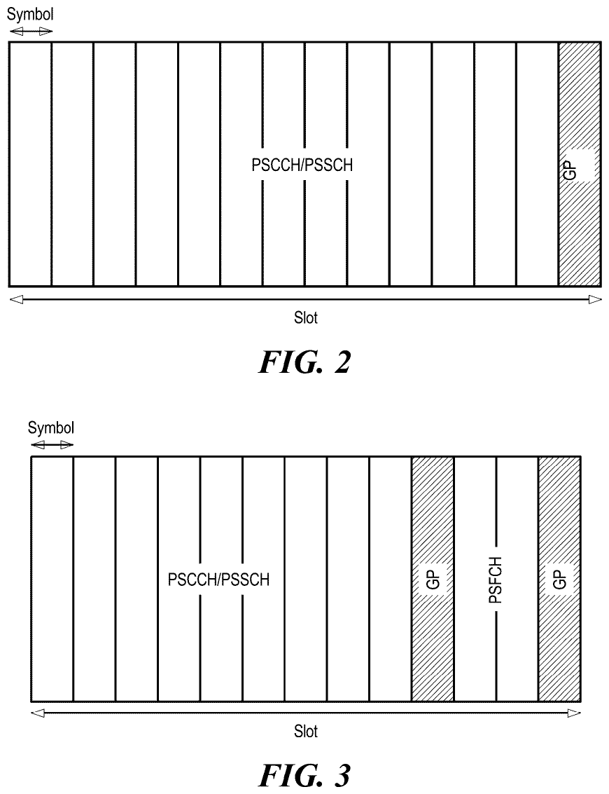

### DETAILED DESCRIPTION

Before describing in detail example embodiments, it is noted that the embodiments reside primarily in combinations of apparatus components and processing steps related to New Radio (NR) resource pool configuration for coexistence with Long Term Evolution (LTE) sidelink. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide New Radio (NR) resource pool configuration for coexistence with Long Term Evolution (LTE) sidelink.

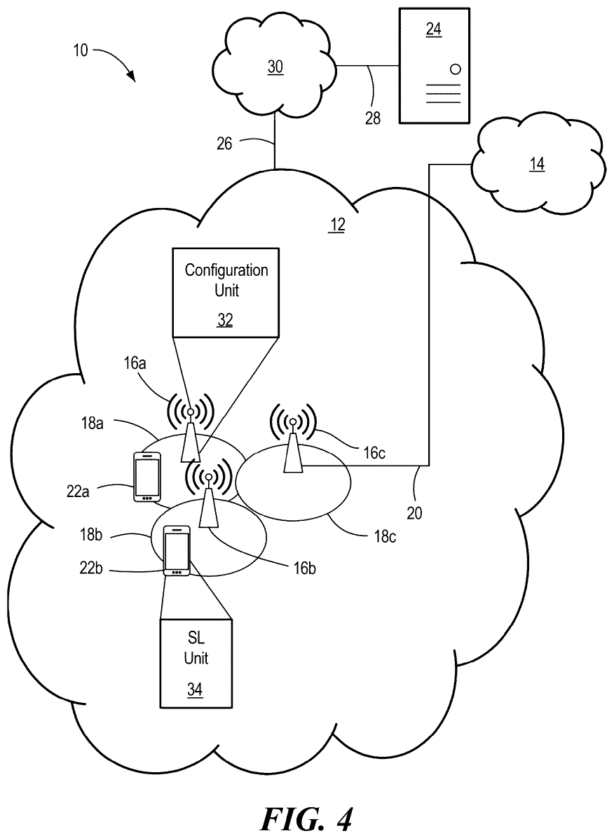

Referring again to the drawing figures, in which like elements are referred to by like reference numerals, there is shown in FIG. 4 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 4 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which is configured to configure a WD to determine whether to perform a SL transmission based at least in part on whether a corresponding physical sidelink feedback channel (PSFCH) transmission will take place in a time slot that is aligned between New Radio (NR) and long term evolution (LTE) resource pools. A wireless device 22 is configured to include an SL unit 34 which is configured to determine whether to perform a sidelink (SL) transmission based at least in part on whether a corresponding physical sidelink feedback channel (PSFCH) transmission will take place in a time slot that is aligned between New Radio (NR) and Long Term Evolution (LTE) resource pools.

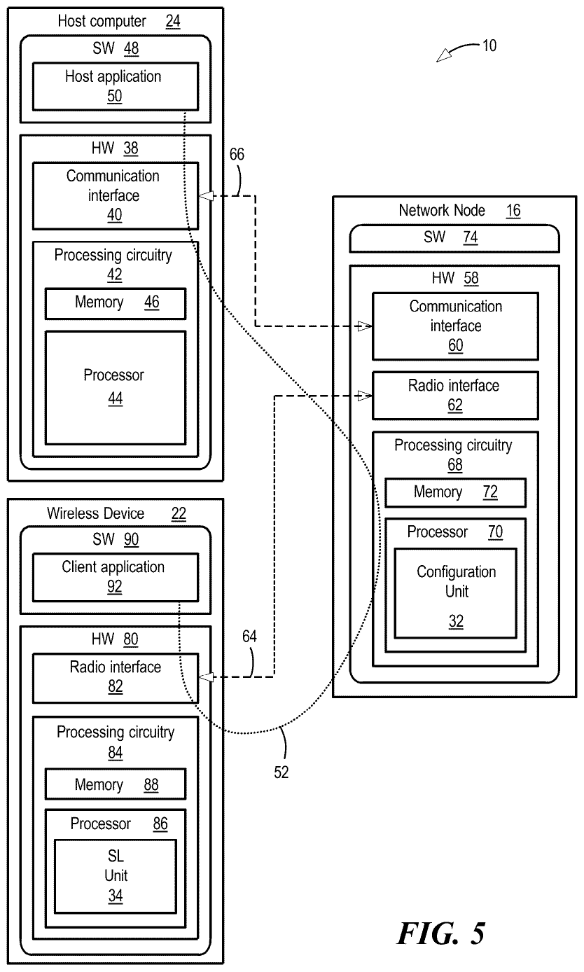

Example implementations, in accordance with an embodiment, of the WD 22, network node 16 and host computer 24 discussed in the preceding paragraphs will now be described with reference to FIG. 5. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In some embodiments, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a configuration unit 32 which is configured to configure a WD to determine whether to perform a SL transmission based at least in part on whether a corresponding physical sidelink feedback channel (PSFCH) transmission will take place in a time slot that is aligned between New Radio (NR) and long term evolution (LTE) resource pools.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an SL unit 34 which is configured to determine whether to perform a sidelink (SL) transmission based at least in part on whether a corresponding physical sidelink feedback channel (PSFCH) transmission will take place in a time slot that is aligned between New Radio (NR) and Long Term Evolution (LTE) resource pools.

In some embodiments, the inner workings of the network node 16, WD 22, and host computer 24 may be as shown in FIG. 5 and independently, the surrounding network topology may be that of FIG. 4.

In FIG. 5, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 4 and 5 show various “units” such as configuration unit 32, and SL unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

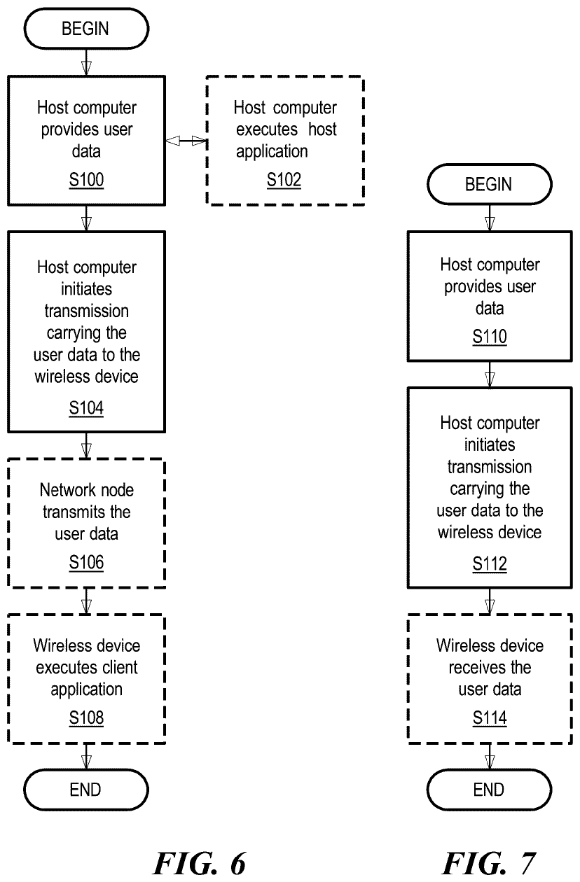

FIG. 6 is a flowchart illustrating an example method implemented in a communication system, such as, for example, the communication system of FIGS. 4 and 5, in accordance with one embodiment. The communication system may include a host computer 24, a network node 16 and a WD 22, which may be those described with reference to FIG. 5. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 7 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

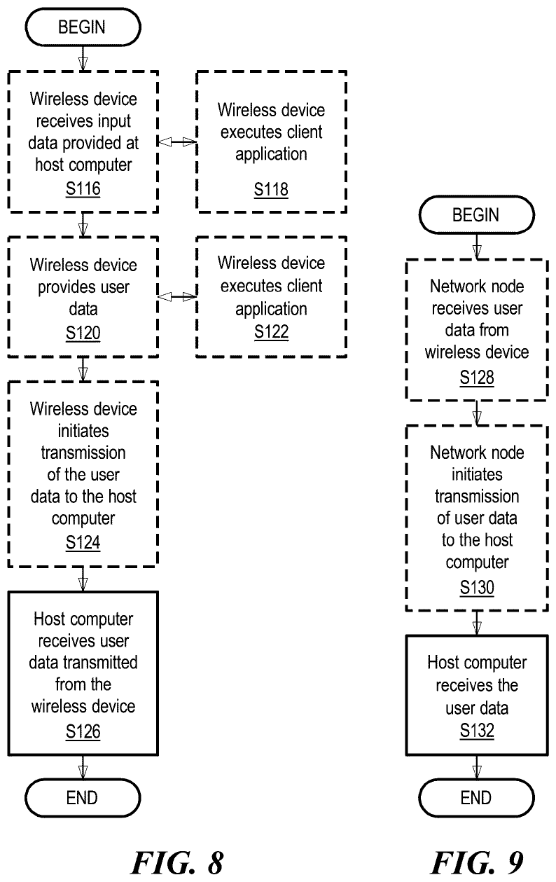

FIG. 8 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 9 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

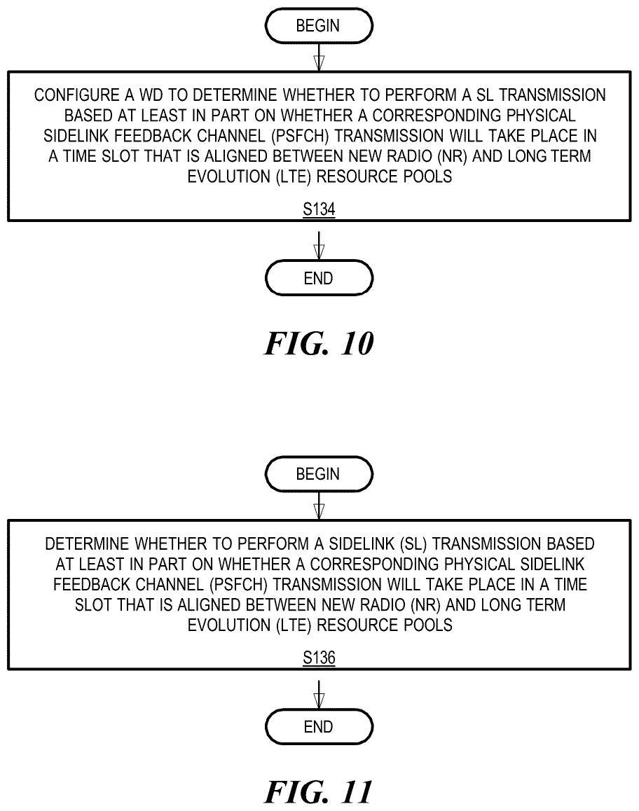

FIG. 10 is a flowchart of an example process in a network node 16 for New Radio (NR) resource pool configuration for coexistence with Long Term Evolution (LTE) sidelink. One or more blocks described herein may be performed by one or more elements of network node 16 such as by one or more of processing circuitry 68 (including the configuration unit 32), processor 70, radio interface 62 and/or communication interface 60. Network node 16 such as via processing circuitry 68 and/or processor 70 and/or radio interface 62 and/or communication interface 60 is configured to configure a WD to determine whether to perform a SL transmission based at least in part on whether a corresponding physical sidelink feedback channel (PSFCH) transmission will take place in a time slot that is aligned between New Radio (NR) and long term evolution (LTE) resource pools (Block S134).

In some embodiments, the method includes configuring the WD 22 to avoid selecting resources for physical sidelink control channel, PSCCH, transmission and physical sidelink shared channel, PSSCH, transmission when the corresponding PSFCH transmission would take place in a time slot that is misaligned between NR and LTE resource pools. In some embodiments, the SL transmission is at least one of a PSCCH transmission and a PSSCH transmission having SL hybrid automatic repeat request, HARQ, feedback in the corresponding PSFCH transmission. In some embodiments, the method includes configuring the WD 22 to perform the SL transmission when the corresponding PSFCH transmission would occur in a slot that is aligned between NR and LTE resource pools, and avoid performing the SL transmission when the corresponding PSFCH transmission would occur in a slot that is misaligned between NR and LTE resource pools.

FIG. 11 is a flowchart of an example process in a wireless device 22 according to some embodiments of the present disclosure. One or more blocks described herein may be performed by one or more elements of wireless device 22 such as by one or more of processing circuitry 84 (including the SL unit 34), processor 86, radio interface 82 and/or communication interface 60. Wireless device 22 such as via processing circuitry 84 and/or processor 86 and/or radio interface 82 is configured to determine whether to perform a sidelink (SL) transmission based at least in part on whether a corresponding physical sidelink feedback channel (PSFCH) transmission will take place in a time slot that is aligned between New Radio (NR) and Long Term Evolution (LTE) resource pools (Block S136).

In some embodiments, the method includes avoiding selecting resources for physical sidelink control channel (PSCCH) transmission and physical sidelink shared channel (PSSCH) transmission. In some embodiments, the method includes avoiding selecting resources for PSCCH and PSSCH transmission only when the corresponding PSFCH transmission would take place in a time slot that is misaligned between NR and LTE resource pools. In some embodiments, the SL transmission is at least one of a PSCCH transmission and a PSSCH transmission having SL hybrid automatic repeat request (HARQ) feedback in a corresponding PSFCH transmission. In some embodiments, the method includes performing the SL transmission when the corresponding PSFCH transmission would occur in a slot that is aligned between NR and LTE resource pools, and avoid performing the SL transmission when the corresponding PSFCH transmission would occur in a slot that is misaligned between NR and LTE resource pools. In some embodiments, not performing a SL transmission includes not selecting a specific resource for SL transmission. In some embodiments, a misalignment of a time slot between NR and LTE resource pools occurs when the time slots of an NR resource pool for PSFCH transmission are configured and the PSFCH transmission does not correspond to a periodically repeating pattern of resources in the LTE resource pool. In some embodiments, a misalignment of a time slot between NR and LTE resource pools occurs when the time slots of an NR resource pool for PSFCH transmission are not configured and the PSFCH transmission corresponds to a periodically repeating pattern of resources in the LTE resource pool. In some embodiments, the WD 22 is configured as a NR type-A device and the method includes selecting a NR sidelink synchronization signal, SLSS, configuration that minimizes misalignment between logical and physical slots at a LTE SL WD 22. In some embodiments, a periodicity of NR PSFCH transmissions is 2 or 4.

Having described the general process flow of arrangements of the disclosure and having provided examples of hardware and software arrangements for implementing the processes and functions of the disclosure, the sections below provide details and examples of arrangements for New Radio (NR) resource pool configuration for coexistence with Long Term Evolution (LTE) sidelink.

Some embodiments described herein include a method for controlling NR SL transmissions depending on (pre-) configurations and certain conditions. The configurations involve NR resource pool (pre-) configurations as well as resource pool configurations. The NR SL resource pool (pre-) configuration may be provided in the usual way. How the LTE SL resource pool is provided is outside the scope of this disclosure. Note that a wireless device may integrate both NR SL communications functionalities (e.g., an NR WD 22 or an NR communications module) and LTE SL communications functionalities (e.g., an LTE WD 22 or a LTE communications module). Thus, some embodiments include a method implemented in an NR SL WD 22 or a method in a device that includes an NR SL WD 22.

Denote by

$$( {t}_{0}^{LTE - SL} , {t}_{1}^{LTE - SL} , … , {t}_{{T}_{max}}^{LTE - SL} )$$

the set of subframes that may belong to a PSSCH resource pool for LTE SL transmission, which are called logical subframes. They do not include sidelink synchronization signals (SLSS) and reserved subframes and hence do not appear contiguously in the time domain.

A similar situation occurs in NR sidelink as well, i.e., the logical slots

$$( {t}_{0}^{NR - SL} , {t}_{1}^{NR - SL} , … , {t}_{{T}_{max}}^{NR - SL} )$$

do not account for SLSS and reserved subframes. NR SL WDs 22 may identify this mapping between logical and physical slots with the knowledge about their own NR SLSS and reserved slots but may not have the knowledge about other radio access technology, i.e., LTE, SLSS.

Altogether, the periodic relationship between PSFCH resources in NR and resources used for RSSI detection in LTE is not always guaranteed when they operate on different scales of logical slots than in physical slots.

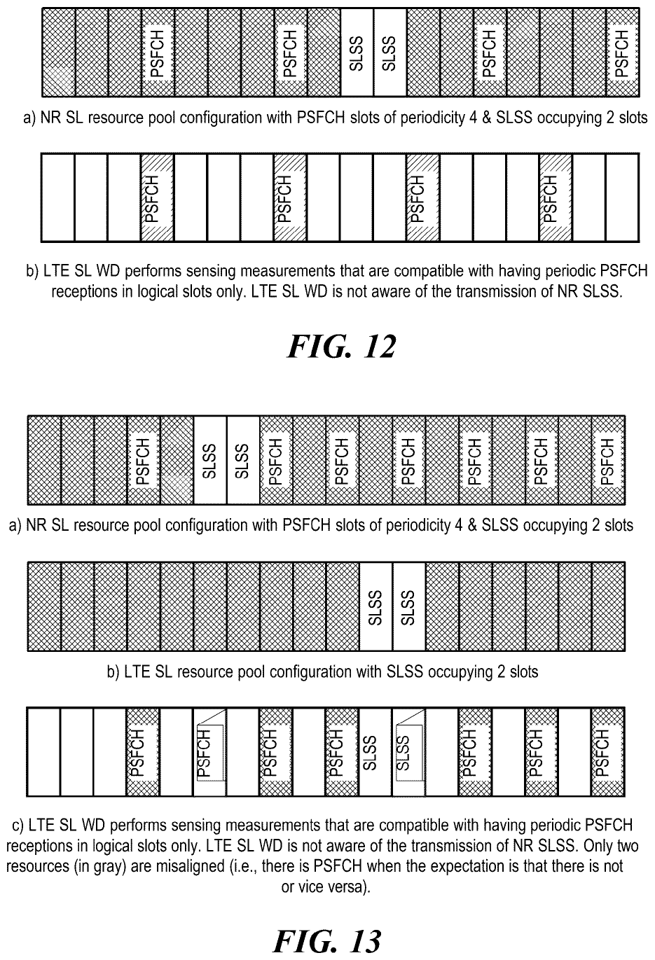

FIG. 12 shows an example where the mismatch between logical and physical slots makes it difficult for LTE SL WD 22 to detect PSFCH transmissions based on RSSI measurement, whereby third and fourth PSFCH slots are perceived incorrectly by the LTE SL WD 22. Slot diagram (a) in FIG. 12 shows a NR SL resource pool configuration with PSFCH slots of periodicity 4 and SLSS occupying 2 slots. Specifically, in this example, PSFCH slots are aligned between logical and physical slots before SLSS slot, but are misaligned after the insertion of SLSS. The LTE SL WD 22, using its sensing procedure would use sensing metrics averaging measurements in the slots labelled as PSFCH in slot diagram (b) in FIG. 12. This would correspond to two slots in which the NR SL WDs 22 may perform PSFCH transmissions, but also two slots in which the NR SL WDs 22 may certainly not perform PSFCH transmissions.

Note that the mismatch or misalignment may only affect a few slots. For example in FIG. 13, there are two slots that are misaligned:
The slot labelled as PSFCH in which:
The NR SL WDs 22 do not perform PSFCH transmission (that slot is dedicated to SLSS transmission/reception by NR SL WDs 22); and/or.
The LTE SL WD 22 performs sensing in a way that would require that PSFCH is transmitted in such resources to produce correct sensing results;
The slot labelled as SLSS in which:
The NR SL WDs 22 may perform PSFCH transmission; and/or
The LTE SL WD 22 does not perform sensing (that slot is dedicated to SLSS transmission/reception).

Note that slot diagram (a) in FIG. 13 is an example of an NR SL resource pool configuration with PSFCH slots of periodicity 4 and SLSS occupying 2 slots, and slot diagram (b) in FIG. 13 is an example of an LTE SL pool configuration with SLSS occupying 2 slots. Some embodiments include determining whether to make a sidelink NR transmission by considering the (pre-) configurations of the NR resource pool and the LTE resource pool:
The WD 22 determines to performs a SL transmission if the corresponding PSFCH transmission would take place in a slot that is aligned between NR and LTE resource pools; and/or
The WD 22 determines not perform a SL transmission if the corresponding PSFCH transmission would take place in a slot that is misaligned between NR and LTE resource pools.

In addition, some embodiments may make use of a periodically repeating pattern of resources in which the LTE SL WD 22 performs measurements. This periodically repeating pattern may or may not be explicit in the specifications. This pattern repeats periodically in the domain of logical subframes (e.g., on the subframes that are part of one or serval resource pools). This corresponds to slot diagram (c) in FIG. 13.

### Embodiments Related to the Transmissions

This section provides details as to the meaning of “a SL transmission” and “the corresponding PSFCH transmission” and their relationship.

In some embodiments, the SL transmission refers to the transmission of PSFCH itself. That is, the WD 22 performs a PSFCH transmission or not depending on whether the corresponding resource is in an aligned or misaligned slot.

In some embodiments, the SL transmission refers to the transmission of a PSCCH/PSSCH with SL HARQ feedback in the corresponding PSFCH transmission. That is, the WD 22 performs a PSCCH/PSSCH transmission or not depending on whether the resource for the corresponding PSFCH transmission is in an aligned or misaligned slot.

### Embodiments Related to the Determination:

In this section, details on the meaning of “The WD 22 determines (not) to perform a SL transmission” are provided.

In some embodiments, determining (not) to perform a SL transmission implies selecting or avoiding selecting a specific resource for a sidelink transmission.

In some embodiments, determining (not) to perform a SL transmission implies (not) performing a transmission on a selected resource.

### Embodiments Related to the Misaligned Slots:

This section provides details on the meaning of “in a slot that is misaligned between NR and LTE resource pools”.

There are two types of misalignments. A slot may be misaligned between NR and LTE resource pools if either of the following happen:
The NR resource pool configures the slots for PSFCH transmission (i.e., PSFCH transmission may take in that slot), but it does not correspond to a periodically repeating pattern of resources in the LTE resource pool (that is, in the logical slots used for LTE SL transmissions). In this case, the LTE sensing procedure may miss the slot (e.g., its sensing procedure may not perform measurements that allow for detecting the presence of NR SL transmissions including PSFCH); and/or
The NR resource pool does not configure a slot for PSFCH transmission, but it corresponds to a periodically repeating pattern of resources in the LTE resource pool. In this case, the LTE sensing procedure may sense in the slot but the result may be misleading (e.g., its sensing procedure may perform measurements that allow for detecting the presence of NR SL transmissions including PSFCH on resources where there is no PSFCH transmission).

Some embodiments may be applied for only one of the misalignment types (and not for the other type) or it may be applied for both types.

### EXAMPLES

In some embodiments, a PSCCH/PSSCH TX WD 22 avoids selecting resources for PSCCH/PSSCH transmission such that there is no necessity to transmit PSFCH in the misaligned slots. For instance, before SLSS slots (and reserved slots, if any), where there exists alignment between logical and physical slots, the PSCCH/PSSCH TX WD 22 may schedule its transmissions.

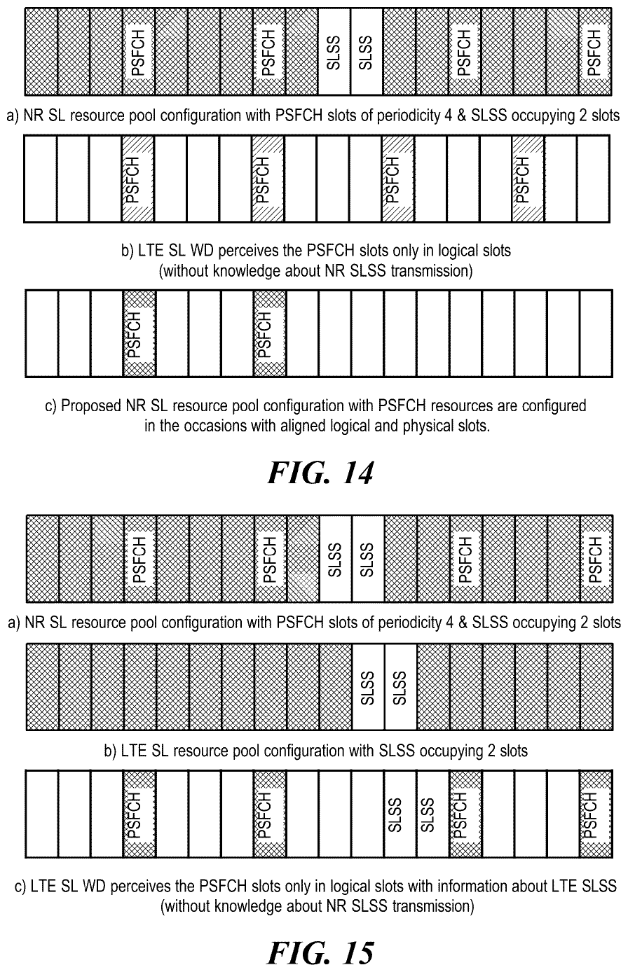

FIG. 14. is an illustration of the mismatch between logical and physical slots, which induces a problem in detecting periodicity of PSFCH transmission at the LTE SL WD 22. Slot diagram (a) in FIG. 14 is an example of an NR SL resource pool configuration with PSFCH slots of periodicity 4 and SLSS occupying 2 slots, and slot diagram (b) in FIG. 14 is an example LTE SL where WD 22 perceives the PSFCH slots only in logical slots (without knowledge of the NR SLSS transmission). PSFCH periodicity is set to 4 and two SLSS slots occur per 160 ms interval. Also shown in slot diagram (c) of FIG. 14, in some embodiments, the PSCCH/PSSCH TX WD 22 avoids selecting resources for transmission such that there is no necessity to transmit PSFCH in the misaligned slots.

In some embodiments, in a type-A device, an NR SL WD 22 may obtain the information about LTE SLSS and choose the NR SLSS configuration such that the issue of misalignment between logical and physical slots is minimized at the LTE SL WD 22.

FIG. 15 illustrates an NR resource pool configuration with its SLSS and an LTE resource pool configuration with its SLSS. Both configurations together help in alleviating the misalignment of logical and physical time slots with respect to PSFCH slots. In FIG. 15, NR PSFCH periodicity is set to 4 and two SLSS slots exist per 160 ms interval. Slot diagram (a) in FIG. 15 is an example of an NR SL resource pool configuration with PSFCH slots of periodicity 4 and SLSS occupying 2 slots. Slot diagram (b) in FIG. 15 is an example of an LTE SL resource pool configuration with SLSS occupying 2 slots, and slot diagram (c) in FIG. 15 is an example of LTE SL where WD 22 perceives PSFCH slots only in logical slots with information about LTE SLSS (without knowledge of the NR SLSS transmission).

In this disclosure all the examples are presented with respect to NR PSFCH periodicity set to 4. In some embodiments, the principles are also applicable to the case of NR PSFCH periodicity set to 2.

Some embodiments may include one or more of the following:

Embodiment A1. A network node configured to communicate with a wireless device (WD), the network node configured to, and/or comprising a radio interface and/or comprising processing circuitry configured to:
configure a WD to determine whether to perform a sidelink (SL) transmission based at least in part on whether a corresponding physical sidelink feedback channel (PSFCH) transmission will take place in a time slot that is not misaligned between New Radio (NR) and long term evolution (LTE) resource pools.

Embodiment A2. The network node of Embodiment A1, wherein the network node, radio interface and/or processing circuitry are configured to configure the WD to avoid selecting resources for physical sidelink control channel (PSCCH) transmission and physical sidelink shared channel (PSSCH) transmission.

Embodiment A3. The network node of Embodiment A2, wherein the SL transmission is at least one of a PSCCH transmission and a PSSCH transmission having SL hybrid automatic repeat request (HARQ) feedback in a corresponding PSFCH transmission.

Embodiment A4. The network node of Embodiment A1, wherein the SL transmission is a PSFCH transmission.

Embodiment B1. A method implemented in a network node configured to communicate with a wireless device, WD, the method comprising:
configuring a WD to determine whether to perform a sidelink (SL) transmission based at least in part on whether a corresponding physical sidelink feedback channel (PSFCH) transmission will take place in a time slot that is not misaligned between New Radio (NR) and long term evolution (LTE) resource pools.

Embodiment B2. The method of Embodiment B1, further comprising configuring the WD to avoid selecting resources for physical sidelink control channel (PSCCH) transmission and physical sidelink shared channel (PSSCH) transmission.

Embodiment B3. The method of Embodiment B2, wherein the SL transmission is at least one of a PSCCH transmission and a PSSCH transmission having SL hybrid automatic repeat request (HARQ) feedback in a corresponding PSFCH transmission.

Embodiment B4. The method of Embodiment B1, wherein the SL transmission is a PSFCH transmission.

Embodiment C1. A wireless device (WD) configured to communicate with a network node, the WD configured to, and/or comprising a radio interface and/or processing circuitry configured to:
determine whether to perform a sidelink (SL) transmission based at least in part on whether a corresponding physical sidelink feedback channel (PSFCH) transmission will take place in a time slot that is not misaligned between New Radio (NR) and Long Term Evolution (LTE) resource pools.

Embodiment C2. The WD of Embodiment C1, wherein the WD, radio interface and/or processing circuitry are configured to avoid selecting resources for physical sidelink control channel (PSCCH) transmission and physical sidelink shared channel (PSSCH) transmission.

Embodiment C3. The WD of Embodiment C2, wherein the SL transmission is at least one of a PSCCH transmission and a PSSCH transmission having SL hybrid automatic repeat request (HARQ) feedback in a corresponding PSFCH transmission.

Embodiment C4. The WD of Embodiment C1, wherein the SL transmission is a PSFCH transmission.

Embodiment C5. The WD of any of Embodiments C1-C4, wherein not performing a SL transmission includes not selecting a specific resource for SL transmission.

Embodiment C6. The WD of any of Embodiments C1-C5, wherein a misalignment of a time slot between NR and LTE resource pools occurs when the time slots of an NR resource pool for PSFCH transmission are configured but the PSFCH transmission does not correspond to a periodically repeating pattern of resources in the LTE resource pool.

Embodiment C7. The WD of any of Embodiments C1-C5, wherein a misalignment of a time slot between NR and LTE resource pools occurs when the time slots of an NR resource pool for PSFCH transmission are not configured but the PSFCH transmission corresponds to a periodically repeating pattern of resources in the LTE resource pool.

Embodiment D1. A method implemented in a wireless device (WD), the method comprising:
determining whether to perform a sidelink (SL) transmission based at least in part on whether a corresponding physical sidelink feedback channel (PSFCH) transmission will take place in a time slot that is not misaligned between New Radio (NR) and Long Term Evolution (LTE) resource pools.

Embodiment D2. The method of Embodiment D1, further comprising avoiding selecting resources for physical sidelink control channel (PSCCH) transmission and physical sidelink shared channel (PSSCH) transmission.

Embodiment D3. The method of Embodiment D2, wherein the SL transmission is at least one of a PSCCH transmission and a PSSCH transmission having SL hybrid automatic repeat request (HARQ) feedback in a corresponding PSFCH transmission.

Embodiment D4. The method of Embodiment D1, wherein the SL transmission is a PSFCH transmission.

Embodiment D5. The method of any of Embodiments D1-D4, wherein not performing a SL transmission includes not selecting a specific resource for SL transmission.

Embodiment D6. The method of any of Embodiments D1-D5, wherein a misalignment of a time slot between NR and LTE resource pools occurs when the time slots of an NR resource pool for PSFCH transmission are configured but the PSFCH transmission does not correspond to a periodically repeating pattern of resources in the LTE resource pool.

Embodiment D7. The method of any of Embodiments D1-D5, wherein a misalignment of a time slot between NR and LTE resource pools occurs when the time slots of an NR resource pool for PSFCH transmission are not configured but the PSFCH transmission corresponds to a periodically repeating pattern of resources in the LTE resource pool.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

### Abbreviation Explanation

CAM Connected and Automated Mobility
CBR Channel Busy Ratio
D2D Device to Device
DL Downlink
FDM Frequency Division Multiplex
ITS Intelligent Transport Systems
LCH Logical Channel
LCG Logical Channel Group
LTE Long Term Evolution
NR New Radio
NW Network
PHY Physical
PSBCH Physical Sidelink Broadcast Channel
PSCCH Physical Sidelink Control Channel
PSSCH Physical Sidelink Shared Channel
RSRP Reference Signal Received Power
RRC Radio Resource Control
RSSI Received Signal Strength Indicator
SCI Sidelink Control Information
SIM Subscriber Identity Module
SL Sidelink
TDM Time Division Multiplex
UC Use Case
UE User Equipment
UL Uplink
URLLC Ultra Reliable Low Latency Communications
WD Wireless Device

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device, WD, configured to communicate with another WD, the WD configured to:
determine whether to perform a sidelink, SL, transmission based at least in part on whether a corresponding physical sidelink feedback channel, PSFCH, transmission will take place in a time slot that is aligned between New Radio, NR, and Long Term Evolution, LTE, resource pools.

2. The WD of claim 1, wherein the WD is configured to avoid selecting resources for physical sidelink control channel, PSCCH, transmission and physical sidelink shared channel, PSSCH, transmission.

3. The WD of claim 2, wherein the WD is configured to avoid selecting resources for PSCCH and PSSCH transmission only when the corresponding PSFCH transmission would take place in a time slot that is misaligned between NR and LTE resource pools.

4. The WD of claim 1, wherein the SL transmission is at least one of a PSCCH transmission and a PSSCH transmission having SL hybrid automatic repeat request (HARQ) feedback in a corresponding PSFCH transmission.

5. The WD of claim 1, wherein the WD is configured to perform the SL transmission when the corresponding PSFCH transmission would occur in a slot that is aligned between NR and LTE resource pools, and avoid performing the SL transmission when the corresponding PSFCH transmission would occur in a slot that is misaligned between NR and LTE resource pools.

6. The WD of claim 1, wherein not performing a SL transmission includes not selecting a specific resource for SL transmission.

7. The WD of claim 1, wherein a misalignment of a time slot between NR and LTE resource pools occurs when the time slots of an NR resource pool for PSFCH transmission are configured and the PSFCH transmission does not correspond to a periodically repeating pattern of resources in the LTE resource pool.

8. The WD of claim 1, wherein a misalignment of a time slot between NR and LTE resource pools occurs when the time slots of an NR resource pool for PSFCH transmission are not configured and the PSFCH transmission corresponds to a periodically repeating pattern of resources in the LTE resource pool.

9. The WD of claim 1, wherein the WD is configured as a NR type-A device and is configured to select a NR sidelink synchronization signal, SLSS, configuration that minimizes misalignment between logical and physical slots at a LTE SL WD.

10. The WD of claim 1, wherein a periodicity of NR PSFCH transmissions is 2 or 4.

11. A method implemented in a wireless device WD, the method comprising:
determining whether to perform a sidelink, SL, transmission based at least in part on whether a corresponding physical sidelink feedback channel, PSFCH, transmission will take place in a time slot that is aligned between New Radio, NR, and Long Term Evolution, LTE, resource pools.

12-24. (canceled)

25. A method implemented in a network node configured to communicate with a wireless device, WD, the method comprising:
configuring the WD to determine whether to perform a sidelink, SL, transmission based at least in part on whether a corresponding physical sidelink feedback channel, PSFCH, transmission will take place in a time slot that is aligned between New Radio, NR, and long term evolution, LTE, resource pools.

26. The method of claim 25, further comprising configuring the WD to avoid selecting resources for physical sidelink control channel, PSCCH, transmission and physical sidelink shared channel, PSSCH, transmission when the corresponding PSFCH transmission would take place in a time slot that is misaligned between NR and LTE resource pools.

27. The method of claim 26, wherein the SL transmission is at least one of a PSCCH transmission and a PSSCH transmission having SL hybrid automatic repeat request, HARQ, feedback in the corresponding PSFCH transmission.

28. The method of claim 25, further comprising configuring the WD to perform the SL transmission when the corresponding PSFCH transmission would occur in a slot that is aligned between NR and LTE resource pools, and avoid performing the SL transmission when the corresponding PSFCH transmission would occur in a slot that is misaligned between NR and LTE resource pools.

29. The WD of claim 4, wherein the SL transmission is a PSCCH transmission.

30. The WD of claim 4, wherein the SL transmission is a PSSCH transmission.

31. The WD of claim 10, wherein the periodicity is 2.

32. The WD of claim 10, wherein the periodicity is 4.
